(19) United States
(12) Patent Application Publication
(10) Pub. No.: US 2022/0109341 A1
(43) Pub. Date: Apr. 7, 2022

(54) CONNECTION UNIT FOR ELECTRIC MOTOR

(71) Applicant: Brose Fahrzeugteile SE & Co. Kommanditgesellschaft, Würzburg, Würzburg (DE)

(72) Inventors: Karl KRUG, Clawson, MI (US); James SALO, Waterford, MI (US); Wolfgang STRAUß, Unterpleichfeld (DE)

(73) Assignee: Brose Fahrzeugteile SE & Co. Kommanditgesellschaft, Würzburg, Würzburg (DE)

(21) Appl. No.: 17/061,109

(22) Filed: Oct. 1, 2020

(51) Int. Cl. H02K 3/50; H02K 3/38; H02K 15/00

(52) U.S. Cl. CPC H02K 3/50; H02K 2203/09; H02K 15/0062; H02K 3/38

(57) ABSTRACT

An electric motor including a stator, an end insulator, and a connection unit is provided. The stator may extend in an axial direction and may include a winding wire. The connection unit may include a housing and a lead frame. The housing may have an annular shape and may include an inner periphery, an outer periphery, and a medial portion extending therebetween. The housing may include a protrusion that may extend in an axial direction from the medial portion. The lead frame may include a number of busbars that may be coupled to the housing and fixed to the winding wire. The protrusion may contact an inner periphery of the end insulator or the stator.

### TECHNICAL FIELD

The present disclosure relates to an electric motor, such as a brushless electric motor.

### BACKGROUND

Electric motors such as brushless electric motors may include a number of electromagnets that may generate a magnetic field during operation. The magnetic field may be adjusted to alter or set a speed of the motor. The motor may include a number of electronics such as a printed circuit board that may alter the flow of electricity to the number of electromagnets. The electromagnets may be coupled to the electronics and a power source by a connection unit.

### SUMMARY

According to one embodiment, an electric motor including a stator, an end insulator, and a connection unit is provided. The stator may extend in an axial direction and may include a winding wire. The connection unit may include a housing and a lead frame. The housing may have an annular shape and may include an inner periphery, an outer periphery, and a medial portion extending therebetween. The housing may include a protrusion that may extend in an axial direction from the medial portion. The lead frame may include a number of busbars that may be coupled to the housing and fixed to the winding wire. The protrusion may contact an inner periphery of the end insulator or the stator.

According to another embodiment, an electric motor including a stator and a connection unit is provided. The stator may include an electric coil, an end insulator, that may be disposed at an end of the stator, and a winding wire that may extend from the electric coil and may be carried by the end insulator. The connection unit may include a housing, a first busbar, and an arm. The housing may have an annular shape and may include an inner periphery, an outer periphery, and a medial portion extending therebetween. The first busbar may include a curved portion, that may extend along the medial portion of the housing, and a distal portion that may extend radially from the curved portion. The arm may extend radially from the housing and may be secured to the end insulator.

According to yet another embodiment, a method of assembling an electric motor including a plurality of stator teeth, a connection unit including a housing, a busbar, an arm, a protrusion, and a shoulder, the protrusion and shoulder each extending from the housing, is provided. the method may include inserting the protrusion into an inner periphery of an end insulator fixed to at least one stator tooth of the plurality of stator teeth. The method may also include positioning the housing so that the shoulder rests on a first protrusion of the end insulator. The method may also include fixing the arm to a second protrusion by inserting at least a portion of the second protrusion into an aperture defined by the arm.

### BRIEF DESCRIPTION OF THE DRAWINGS

FIG. 1 illustrates a perspective view of an exemplary electric motor assembly.

FIG. 2 illustrates a top view of a portion the exemplary electric motor assembly.

FIG. 3 illustrates a perspective view of a portion the exemplary electric motor assembly.

FIG. 4 illustrates a perspective view of an exemplary stator and end insulator of the exemplary electric motor.

FIG. 5 illustrates a perspective view of an exemplary connection unit for use in the electric motor.

FIG. 6 illustrates a top view of the exemplary connection unit.

FIG. 7 illustrates a perspective view of the exemplary connection unit for use in the electric motor.

FIG. 8 illustrates an exemplary circuit diagram of the electric motor assembly.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As used in the specification and the appended claims, the singular form “a,” “an,” and “the” comprise plural referents unless the context clearly indicates otherwise. For example, reference to a component in the singular is intended to comprise a plurality of components.

The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within ±0%, 0.1%, 0.5%, 1%, 2%, 3%, 4%, 5% or 10% of the value or relative characteristic.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Referring generally to the figures, an electric motor 100 is provided. As an example, the electric motor may be a twenty-four-slot-four-parallel-path motor. Twenty-four slot may refer to the number of windings. The term “four-parallel-path” may refer to the number of electrical paths through a phase of a motor. One of the challenges of manufacturing such a motor may be routing winding wires extending from stator electric coils in an efficient manner so that the winding wires may be electrically connected to a wire harness via a connection unit. As an example, the number winding wires may require a substantial amount of space to physically position each of the winding wires and to provide sufficient space for the associated assembly tooling. As another example, fixing the winding wires to the connection unit to create a secure connection between the stator windings and the connection unit may be a challenge. In yet a further example, assembling the connection unit in an economically efficient manner may be difficult.

The electric motor 100 may be used in a vehicle such as an automobile or another vehicle, including but not limited to an electric or pedelec bicycle, a delivery robot or drone.

The electric motor 100 may include a stator 118 that may be disposed within a housing 102 and a shaft 106 that may extend through at least a portion of the housing. The shaft 106 may be fixed to a rotor (not illustrated) and may define a rotational axis R. The term “axial direction” may refer to a direction that is parallel to the rotational axis R. The stator 118 may include a number of electric coils 120 that may be connected, such as wound, around portions of the stator 118 e.g., stator teeth 122. The stator 118 may include an end insulator 116 that may be disposed on an end portion of the stator 118. The end insulator 116 may carry a number of winding wires 124 extending from the electric coils 120.

The electric motor 100 may also include a connection unit 126 that may include a housing 128, a number of busbars 130, and a number of arms 132. The housing 128 may have an annular shape and include an inner periphery 134, an outer periphery 136, and a medial portion 138 extending therebetween. One or more of the busbars 114 may include a curved portion 142 and a distal end 145. The curved portion 142 may extend along the medial portion 138 of the housing 128 and the distal end 145 may extend from the curved portion 142. One or more of the number of arms 132 may extend from the housing 128 and be secured to the end insulator 116.

In one or more embodiments, the end insulator 116 may include a number of protrusions such as towers 144 and the arm 132 may define an aperture 146 that may receive a portion of the tower 144 so that the connection unit 126 is fixed to the end insulator 116. As an example, the aperture 146 and the portion of the tower 144 may cooperatively engage one another to form a snap-fit condition. In other words, as the connection unit 126 is assembled to the end insulator 116, the aperture 146 defined by the arm 132 may snap onto the tower 144.

One or more of the arms 132 may include a bent portion 148 that may be disposed between the outer periphery 136 of the housing 128 and a distal end 150 of the arm 132. The distal end 150 of the arm 132 may be configured to fix the position of the housing 128 in a radial direction with respect to the stator 118. The radial direction may be the direction that is substantially orthogonal to a rotational axis R defined by the shaft 106. The housing 128 may include a number of locating protrusions 152 that may extend from the medial portion 138. The locating protrusions 152 may be arranged along the housing 128 to position the busbars 114 along the medial portion 138 of the housing 128. One or more of the locating protrusions 152 may include a flange 154 that may be configured to fix a busbar 114 in an axial direction. The axial direction may be a direction that is parallel to the rotational axis R.

The housing may include a shoulder 156 and a protrusion 158 that may each extend from the medial portion 138 of the housing 128. As an example, the protrusion 158 and the shoulder 156 may be arranged coaxially to one another. The shoulder 156 may be disposed between the outer periphery 136 and the protrusion 158. The protrusion 158 may be sized and positioned so that an inner periphery 160 of the stator 118, or an inner periphery 162 of the end insulator 116, or both. Because the protrusion 158 is inserted within the inner periphery 160 of the stator 118, or the inner periphery 162 of the end insulator 116, or both, the housing 128 of the connection unit 126 may be positioned in a desired location e.g., centered with respect to the stator 118. In other words, the protrusion may engage the inner periphery of the stator 118 or the end insulator 116 so that the connection unit is radially fixed to the stator 118 and the end insulator 116. The protrusion 158 may be inserted along the axial direction within the stator 118 so that the shoulder 156 may lie against a number of inner protrusions 164 of the end insulator 116.

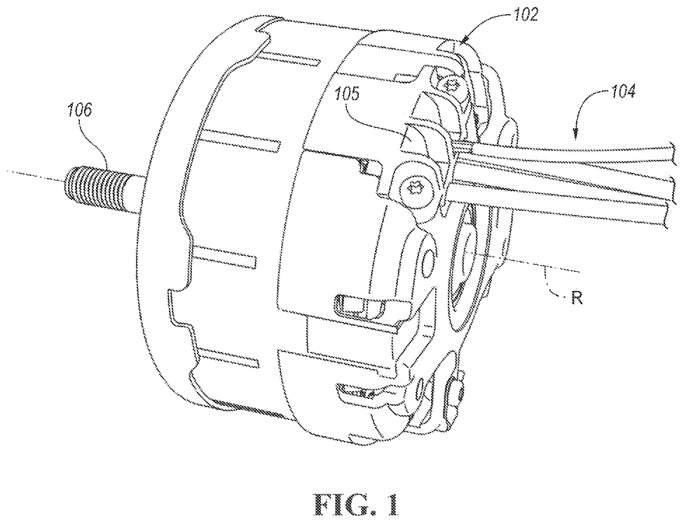

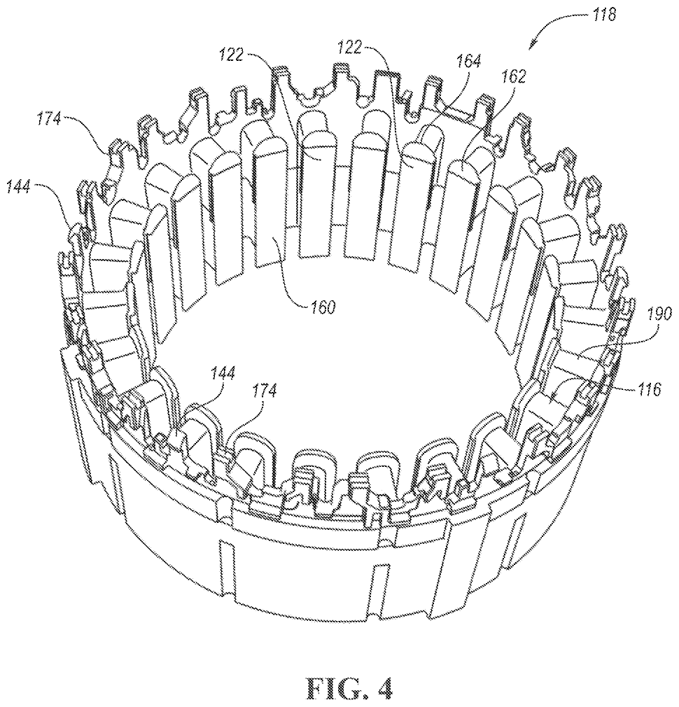

Referring to FIG. 1, a perspective view of the electric motor 100 is illustrated. The electric motor 100 may include the motor housing 102 that may house the stator 118 (FIG. 4) and the rotor (not illustrated). A wire harness 105 may be fixed to the housing and a wire assembly 104 may be attached to wire harness so that the wire assembly 104 is electrically connected to the stator 118.

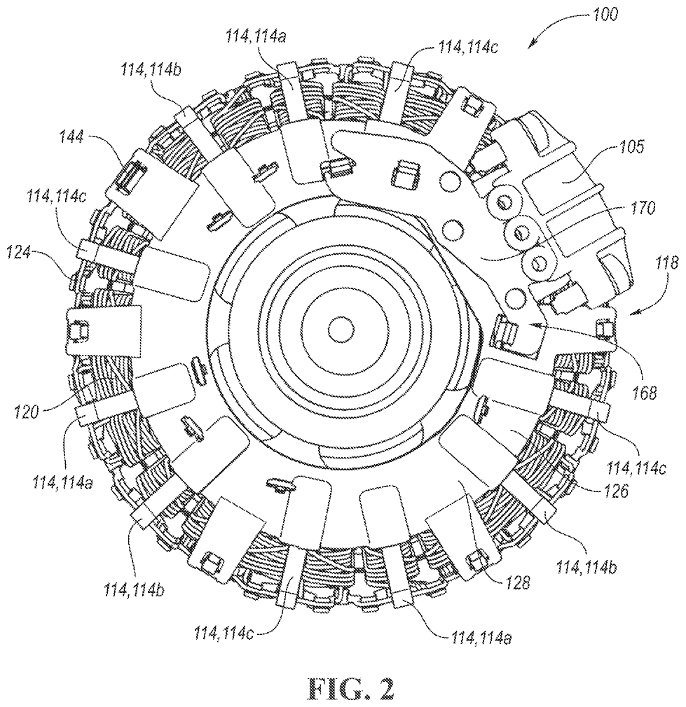

Referring to FIG. 2, a top-view of a portion of the electric motor 100 is illustrated. The electric motor 100 includes the connection unit 126 that may include the housing 128 and a number of busbars 114. The number of busbars 114 may include a first busbar 114a, a second busbar 114b, and a third busbar 114c. The connection unit 126 may include a first arm 132a, a second arm 132b, a third arm 132c, a fourth arm 132d, and a fifth arm 132e each of which may extend radially outward from the housing 128. Each of the arms 132 may be fixed to protrusions, such as the towers 144. The connection unit 126 may include a contact adapter 168 that may include a body 170 and a number of second busbars 172 that may be fixed to the body. As an example, the body may be made from a plastic or polymeric material that may be formed by injection molding. The second busbars 172 may be overmolded to the body 170. The second busbars 172 may electrically connect the wire harness 105 to the each of busbars 114.

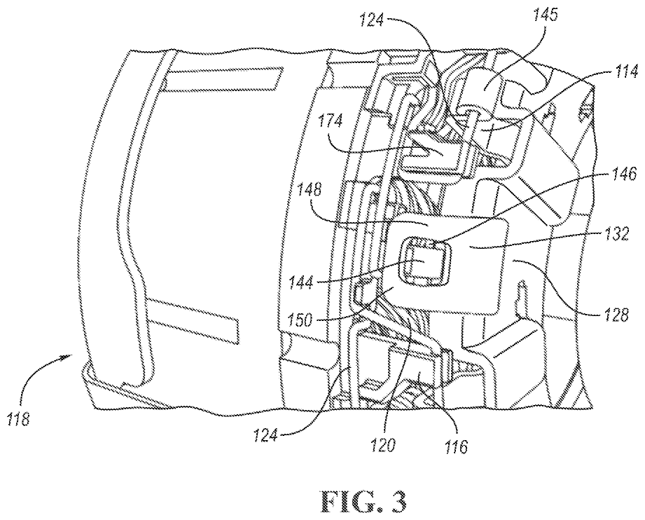

Referring to FIG. 3, a top-perspective view of a portion of the electric motor 100 is illustrated. As stated above, the busbars 114 may be fixed to the winding wire 124 that may be electrically connected to the stator windings 120. The winding wire 124 may be supported by one or more protrusions 174 that may be disposed on each side of towers 144 of the end insulator 116. In one or more embodiments, the distal end 145 of the busbar 114 may be engaged with and electrically fixed to the winding wire 124. As an example, the distal end 145 of the busbar 114 may include a hook that be at least partially wrapped around the winding wire 124.

The distal end 145 of the busbar 114 may be bent by a clamp or a pair of tongs, such as welding tongs so that the pair of tongs bends and welds the distal end 145 to the winding wire 124. The welding may be accomplished by resistance welding, laser welding, or another suitable process. As another example, the distal end 145 may be fixed to the winding wire 124 by heat staking. The term “heat staking” may refer to a pulsed-heat process to join two or more parts by deforming a first part using heat and force at a set process time to fix the first part to two or more other parts. The busbars 114, 172, and the winding wires 124 may each be formed of an electrically conductive material e.g., copper. The distal end 145 of the busbars 114 may be bent so that the hook portion is substantially or completely wrapped around the winding wire 124.

As mentioned above, the end insulator 116 a number of protrusions such as towers 144. The towers 144 may include a flange portion or a lip that may engage an inner periphery of the aperture 146 defined by the arm 132. The distal end 150 of the arm 132 may be disposed on one side of the bent portion 148 and the portion that connects the arm 132 and the housing 128. The distal end 150 may be arranged to fix the connection unit 126 in the axial, radial, or both the axial and radial directions. The distal end 150 may engage the flange portion or lip of the tower 144 to form a snap-fit connection between the tower 144 and the arm 132. As an example, each of the arms 132 may be integrally formed to the housing 128 by plastic injection molding or another suitable process.

Referring to FIG. 4, a perspective view of the stator 118 and the end insulator 116 fixed to the stator 118 is illustrated. The stator 118 may include a number of stator teeth 122 that may extend from an inner periphery of the stator. As an example, a quantity of the number of stator teeth 122 may equal twenty-four. Each of the electric coils 120 (FIG. 3) may be wrapped around each of the stator teeth 122 so that portions of the electric coils 120 are disposed between two stator teeth 122 that are adjacent to one another.

The end insulator 116 may include a include a number of protrusions. For example, an inner portion of the end insulator may include inner protrusions 164 that may extend from each of the stator teeth 122. As an example, the inner protrusions 164 may be curved or arced to form a semi-round shape. One of the protrusions may be referred to as the tower 144 that be positioned radially outward from the protrusions 164. As mentioned above, the tower 144 may include a flange or a lip that may engage one or more of the arms 132. Another number of protrusions 174 may be distributed about a circumference of the end insulator 116. The protrusions 174 may be arranged and configured to carry the winding wires 124. As an example, the protrusions 174 may include a fork portion that may receive portions of the winding wires 124.

The end insulator 116 may be formed by an insulative material such as plastic or another polymeric material. The end insulator may be attached to the stator by overmolding or may be placed or secured by a press-fit connection.

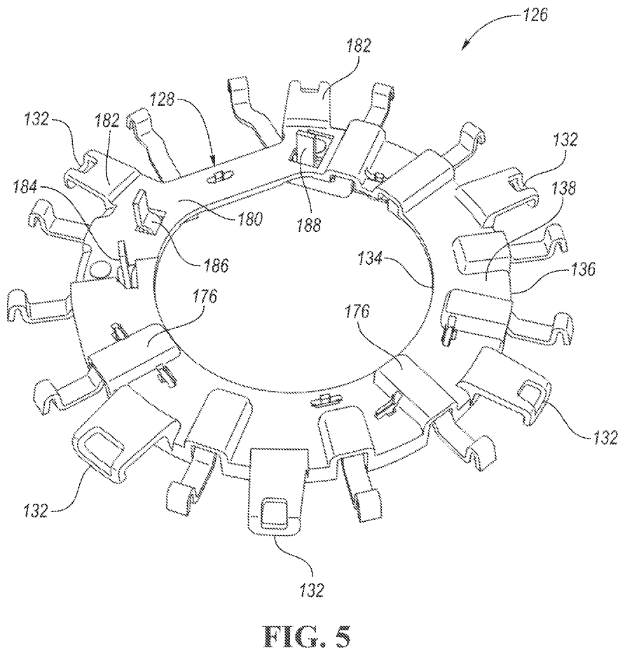

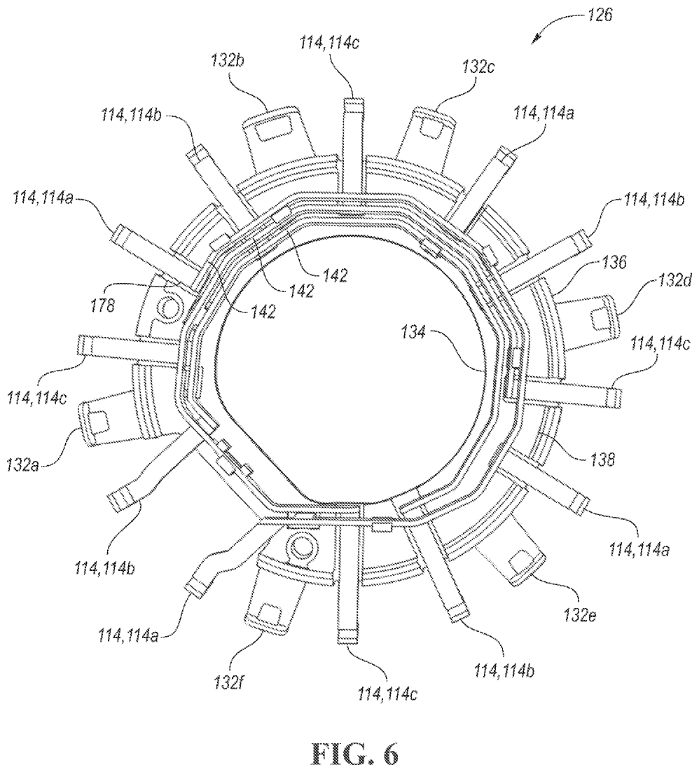

Referring to FIG. 5 and FIG. 6, a top-perspective view of the connection unit 126 and a bottom view of the connection unit are illustrated, respectively. The connection unit 126 may include the housing 128 that may be formed of an electrically insulative material, such as a plastic or a polymeric material. As stated above, the housing 128 may have an annular shape that includes the inner periphery, the outer periphery 136, and a medial portion 138 extending therebetween.

A top surface 180 of the housing 128 may include a number of raised portions 176 and a bottom surface of the housing may define a number of channels 178 that may be disposed substantially opposite to the raised portions 176. The channels 178 and the raised portions 176 may receive at least portions of the busbars 114 so that the distal end 145 may be positioned to engage the winding wires 124 (FIG. 3). The outer periphery 136 of the housing may be formed of a sidewall that may extend between the channels 178. The sidewall may serve as a guard to prevent unwanted debris from entering the inner periphery 160 of the stator 118. As an example, one or more of the arms 132 may include a raised surface 182 that may be disposed above the top surface 180 so that the aperture 146 and distal end 150 of the arm is positioned to engage the towers 144. As an example, because the raised surface 182 of the arms 132 may have a greater cross-sectional thickness than an arm that is in the same plane as the top surface 180, the raised surface 182 may provide increased strength, or structural rigidity, or both.

The contact adapter 168 may lie along or be spaced apart from the top surface 180. The contact adapter 168 may receive end portions 184, 186, 188 of the busbars 114 so that the second busbars 172 are electrically connected to the busbars 114.

The distal ends 145 of the busbars 114a may be located radially with respect to the 132 in a predetermined manner based on the number of arms 132, the number of busbars 114, and the required strength of the connection between the connection unit 126 and the end insulator 116. As an example, distal portions of three busbars 114a, 114b, 114c may be disposed between the first arm 132a and the second arm 132b. A distal portion of the third busbar 114c may be disposed between the second arm 132b and the third arm 132c. A distal portion of the first busbar 114a and the second busbar 114b may be disposed between the third arm 132c and the fourth arm 132d. A distal portion of the third busbar 114c and the first busbar 114a may be disposed between the fourth arm 132d and the fifth arm 132e. Distal portions of the second busbar 114b and the third busbar 114c may be disposed between the fifth arm 132e and the sixth arm 132f. Distal portions of the first busbar 114a and the second busbar 114b may be disposed between the sixth arm 132f and the first arm 132a.

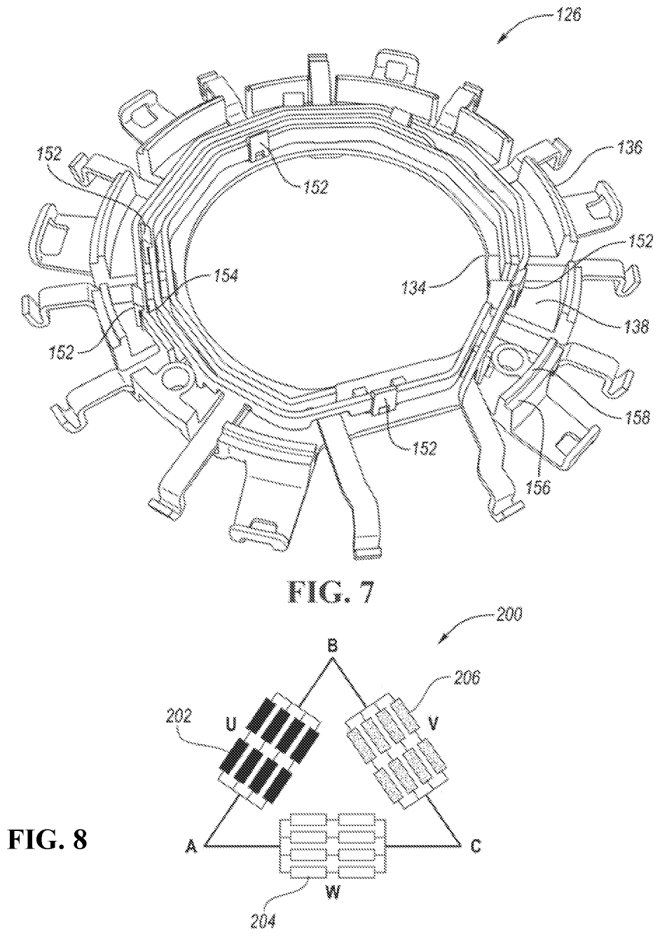

Referring to FIG. 7, a bottom-perspective view of the connection unit 126 is illustrated. The sidewalls that form the outer periphery 136 may include a substantially flat portion that may extend circumferentially about the housing 128. The substantially flat portion may be referred to as a shoulder 156 that may rest along a protrusion such as a medial surface 190 of the end insulator 116. The medial surface 190 (FIG. 4) may set the axial position of the connection unit 126 with respect to the stator 118. The protrusion 158 may extend from the medial portion 138 of the housing 128 so that it is coaxial with respect to the shoulder 156. In one or more embodiments, the shoulder 156 may be disposed radially outwardly from the protrusion 158. An axial wall of the protrusion 158 may engage or contact at least a portion of the inner periphery 160 of the stator 118, or the inner periphery 162 of the end insulator 116, or both. The protrusion 158 may act as a pilot or a locator so that as the pilot is inserted into the inner periphery 162 of the end insulator 116, the housing 128 is located or centered with respect to the stator 118, the end insulator 116, or both.

As mentioned above, the curved portion 142 of one or more of the busbars 114 may extend along the medial portion 138. A number of location tabs or protrusions 152 may extend from the medial portion 138 to locate the busbars 114 with respect to the housing 128. One or more of the locating protrusions may include a flange 154 that may engage and fix the busbars 114 to the housing 128.

Referring to FIG. 8 exemplary circuit diagram 200 of the electric motor assembly 100 is provided. In one or more embodiments, the circuit diagram 200 may be in the form of a delta network, as illustrated. Letters U, V, W represent three different phase windings. As such, the black boxes 202 may represent electric coils 120 (FIG. 2) for phase U, the white boxes 204 may represent electric coils 120 (FIG. 2) for phase W, and the grey boxes 206 may represent electric coils 206 for phase V. As mentioned above, the motor 100 may have twenty-four coil windings. Eight electric coils 120 may be provided for each of the phases U, V, W. The coils 120 may be arranged in to form four parallel paths. For example, pairs of the coil windings are electrically connected in parallel, rather than in series. Letters A, B, C may represent the connections for each of the phases. For example, A may represent the connection for phase U, B may represent the connections for phase V, and C may represent the connections for phase W. As an example, busbars 114a may form the connections A and busbars 114b may form the connections B, and etc.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### PARTS LIST

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.
100 electric motor
102 housing
104 wire assembly
106 shaft
116 end insulator
118 stator
120 electric coils
122 stator teeth
124 winding wires
126 connection unit
128 housing
130 busbars
134 inner periphery of housing
136 outer periphery of housing
138 medial portion of housing
142 curved portion
144 tower
144 towers
145 distal end of busbar
146 aperture
148 bent portion
150 distal end
152 locating protrusions
154 flange
156 shoulder
158 pilot/protrusion
160 inner periphery of stator
162 inner periphery of end insulator
164 inner protrusions
168 contact adapter
170 body
172 second busbars
174 protrusions
176 raised portions
178 channels
180 top surface
182 surface
184 end portions
186 end portions
188 end portions
190 medial surface of end insulator
114, 114a-114e busbars
132, 132a-132e arms
200 circuit
202 U phase windings
204 W phase windings
206 V phase windings
U, V, W Phase windings
A, B, C Connections

What is claimed is:

1. An electric motor comprising:
a stator extending in an axial direction and including a winding wire;
an end insulator disposed on an end of the stator and carrying the winding wire; and
a connection unit including,
a housing having an annular shape and including an inner periphery, an outer periphery, a medial portion extending therebetween, and a protrusion extending in the axial direction from the medial portion, and
a lead frame coupled to the housing and fixed to the winding wire, wherein the protrusion contacts an inner periphery of the end insulator and/or the stator.

2. The electric motor of claim 1, wherein the lead frame includes a number of busbars each including a first portion and a second portion, wherein the first portion extends along the medial portion and the second portion radially and outwardly extends from the first portion, wherein the second portion includes a hook engaged to the winding wire.

3. The electric motor of claim 2, further comprising:
a number of locating pins extending from the medial portion and positioned to secure the first portion of at least one of the busbars of the number of busbars in a radial direction, wherein the radial direction is substantially orthogonal to the axial direction.

4. The electric motor of claim 3, wherein a first locating pin of the number of locating pins includes a flange securing the first portion in the axial direction.

5. The electric motor of claim 1, further comprising:
a shoulder extending from the housing and spaced apart from the inner periphery, wherein the end insulator includes an inner protrusion and the shoulder lies against the inner protrusion of the end insulator.

6. The electric motor of claim 5, wherein the shoulder and the protrusion are coaxial to one another.

7. The electric motor of claim 6, wherein the shoulder and the protrusion are each integrally molded to the housing.

8. The electric motor of claim 7, wherein the stator includes a number of stator teeth each defining the inner periphery of the stator, and the end insulator is disposed on each of the stator teeth.

9. The electric motor of claim 8, wherein a quantity of the number of stator teeth is an even number.

10. An electric motor comprising:
a stator including,
an electric coil,
an end insulator disposed at an end of the stator, and
a winding wire extending from the electric coil and carried by the end insulator; and
a connection unit including,
a housing having an annular shape and including an inner periphery, an outer periphery, and a medial portion extending therebetween,
a first busbar including a curved portion, extending along the medial portion, and a distal portion radially extending from the curved portion, and
an arm radially extending from the housing and secured to the end insulator.

11. The electric motor of claim 10, wherein the end insulator includes a protrusion and the arm defines an aperture configured to receive the protrusion.

12. The electric motor of claim 11, wherein the aperture and the protrusion cooperatively engage one another to form a snap-fit connection.

13. The electric motor of claim 11, wherein the arm includes a bent portion and the bent portion at least partially defines the aperture.

14. The electric motor of claim 13, wherein the arm includes a distal portion extending from the bent portion and the distal portion axially fixes the housing to the end insulator.

15. The electric motor of claim 10, wherein the housing defines a channel extending from the medial portion through the outer periphery, and wherein at least a portion of the distal portion of the busbar is disposed in the channel.

16. The electric motor of claim 10, further comprising:
a wire harness configured to receive a number of wires; and
a contact adapter including a body and a second busbar fixed to the body and electrically connected to the first busbar and the wire harness.

17. The electric motor of claim 16, wherein the second busbar is fixed to the body by overmolding.

18. A method of assembling an electric motor having a stator, including a plurality of stator teeth, a connection unit including a housing, a busbar, an arm, a protrusion, and a shoulder, the protrusion and shoulder each extending from the housing, the method comprising:
inserting the protrusion into an inner periphery of an end insulator fixed to at least one stator tooth of the plurality of stator teeth.

19. The method of claim 18, further comprising:
positioning the housing so that the shoulder rests on a first protrusion of the end insulator.

20. The method of claim 18, further comprising:
fixing the arm to a second protrusion of the end insulator by inserting at least a portion of the second protrusion into an aperture defined by the arm.
